(19) United States
(12) Patent Application Publication
(10) Pub. No.: US 2018/0232820 A1
(43) Pub. Date: Aug. 16, 2018

(54) SYSTEMS AND METHODS FOR COMPUTING AUTHENTICITY SCORES

(71) Applicant: MasterCard International Incorporated, Purchase, NY (US)

(72) Inventor: Manoneet KOHLI, O'Fallon, MO (US)

(21) Appl. No.: 15/429,549

(22) Filed: Feb. 10, 2017

(51) Int. Cl. G06Q 50/12; G06Q 20/40; G06Q 20/34

(52) U.S. Cl. CPC G06Q 50/12; G06Q 20/34; G06Q 20/4014

(57) ABSTRACT

A score authenticator (SA) system that includes a score authenticator (SA) computing device for generating authenticity scores by using device communication data, cardholder profile data, merchant parameter data, and transaction data is provided. The SA computing device is configured to receive merchant parameter data relating to a candidate merchant including a merchant category code and a merchant identifier. The SA computing device is also configured to build at least one authenticity parameter for the candidate merchant using the merchant parameter data, the at least one authenticity parameter representing at least one key characteristic of the merchant. The SA computing device is further configured to identify a cardholder having interacted with the candidate merchant, to match interests of the cardholder to the at least one key characteristic of the candidate merchant, and to generate an authenticity score for the candidate merchant.

### BACKGROUND

This disclosure relates generally to collecting data from computing devices connected in communication by a computer network, and more particularly, to systems and methods for generating authenticity scores by using device communication data, cardholder profile data, merchant parameter data, and transaction data.

Consumers are often provided with an increasing number of segments of entertainment choices available, as well as, an increasing number of merchants available in each segment. A segment is a group of merchants offering a similar entertainment experience, such as a dining segment, an events segment, a night club segment, and an activities segment. For example, in many cities, consumers have hundreds if not thousands of restaurant options when they desire to eat. Moreover, even when the restaurant options are narrowed by restaurant category or cuisine, there may still be an inconveniently large number of restaurant options presented to the consumer. Additionally, new restaurants may become available without the consumer's knowledge.

To try address these issues, various known websites exist that provide restaurant recommendations to consumers. For example, some Internet websites provide to consumers restaurant reviews or scores assigned to restaurants, as well as, provide descriptive information (e.g., average prices, type of cuisine) about the restaurants. Oftentimes, consumers can provide their comments and information on a restaurant in addition to professional reviewers, thereby providing additional opinions for other consumers. One problem that arises with relying on scores and/or reviews provided by other consumers is that some consumers may have different preferences, which can make the scores and/or reviews for a restaurant unreliable for certain consumers. Additionally, in some instances, consumers are more likely to post a review based on a bad experience at a restaurant than they are to post a positive review, which can bias recommendations for other consumers.

Another problem consumers encounter with these known websites that recommend restaurants is when a restaurant claims to have a particular authenticity. For example, a restaurant may claim to be an authentic Italian or Mexican restaurant. Unfortunately, there is no known system that is able to objectively measure the authenticity of a restaurant.

Accordingly, a system is needed that is configured to objectively score or evaluate a merchant (e.g., restaurant) without relying on consumer input, and objectively generate an authenticity score for the same restaurant so that consumers can be better informed to make purchasing decisions.

### BRIEF DESCRIPTION

In one aspect, a score authenticator (SA) system that includes a score authenticator (SA) computing device for generating authenticity scores by using device communication data, cardholder profile data, merchant parameter data, and transaction data is provided. The SA computing device is configured to receive merchant parameter data relating to a candidate merchant including a merchant category code and a merchant identifier. The SA computing device is also configured to build at least one authenticity parameter for the candidate merchant using the merchant parameter data, the at least one authenticity parameter representing at least one key characteristic of the merchant. The SA computing device is further configured to identify a cardholder having interacted with the candidate merchant, to match interests of the cardholder to the at least one key characteristic of the candidate merchant, and to generate an authenticity score for the candidate merchant based on the interests of the cardholder to the at least one key characteristic of the candidate merchant and an experience level of the cardholder in said matching interests.

In another aspect, a computer-based method for generating authenticity scores by using device communication data, cardholder profile data, merchant parameter data, and transaction data is provided. The method includes receiving merchant parameter data relating to a candidate merchant including a merchant category code and a merchant identifier. The method also includes building at least one authenticity parameter for the candidate merchant using the merchant parameter data, the at least one authenticity parameter representing at least one key characteristic of the merchant. The method further includes identifying a cardholder having interacted with the candidate merchant, matching interests of the cardholder to the at least one key characteristic of the candidate merchant, and generating an authenticity score for the candidate merchant based on the interests of the cardholder to the at least one key characteristic of the candidate merchant and an experience level of the cardholder in said matching interests.

In yet another aspect, a non-transitory computer readable medium that includes executable instructions for generating authenticity scores by using device communication data, cardholder profile data, merchant parameter data, and transaction data is provided. When executed by a SA computing device including at least one processor in communication with at least one memory device, the computer executable instructions cause the SA computing device to receive merchant parameter data relating to a candidate merchant including a merchant category code and a merchant identifier. The computer executable instructions also cause the SA computing device to build at least one authenticity parameter for the candidate merchant using the merchant parameter data, the at least one authenticity parameter representing at least one key characteristic of the merchant. The computer executable instructions further cause the SA computing device to identify a cardholder having interacted with the candidate merchant, to match interests of the cardholder to the at least one key characteristic of the candidate merchant, and to generate an authenticity score for the candidate merchant based on the interests of the cardholder to the at least one key characteristic of the candidate merchant and an experience level of the cardholder in said matching interests.

### BRIEF DESCRIPTION OF THE DRAWINGS

FIGS. 1-7 show example embodiments of the methods and systems described herein.

FIG. 1 is a schematic diagram illustrating an example multi-party payment processing system for enabling payment-by-card transactions that includes a score authenticity (SA) computing device for generating authenticity scores by using device communication data, cardholder profile data, transaction data, and merchant parameter data.

FIG. 2 is a simplified block diagram of an example score authenticator (SA) system that includes the SA computing device.

FIG. 3 illustrates an example configuration of a user computing device shown in FIG. 2, in accordance with one embodiment of the present disclosure.

FIG. 4 illustrates an example configuration of a server system shown in FIG. 2, in accordance with one embodiment of the present disclosure.

FIG. 5 is a flow chart showing a process for building at least one a-parameter for a merchant and generating an a-score based on merchant parameter data and a cardholder's a-profile over a network using the system shown in FIG. 2.

FIG. 6 is a diagram of components of one or more example computing devices that may be used in the system shown in FIG. 2.

FIG. 7 illustrates an example configuration of an score authenticator (SA) system that includes the SA computing device configured to collect cardholder profile data, merchant parameter data, and transaction data, and to generate authenticity scores.

Like numbers in the Figures indicate the same or functionally similar components.

### DETAILED DESCRIPTION

The following detailed description illustrates embodiments of the disclosure by way of example and not by way of limitation. The description enables one skilled in the art to make and use the disclosure, describes several embodiments, adaptations, variations, alternatives, and uses of the disclosure, including what is presently believed to be the best mode of carrying out the disclosure. The system and methods described herein are configured to collect device communication data, cardholder profile data, transaction data, and merchant parameter data to generate authenticity scores that may be used, for example, as a tool to create merchant recommendations or to promote merchants' goods and/or services.

The present disclosure relates to a score authenticator computing system (also referred to as “SA computing system”) that is configured to collect merchant parameter data from a merchant, store the merchant parameter data, build an authenticity parameter (also referred to as “a-parameter”) for the merchant, receive cardholder transaction data, assign an authenticity profile (also referred to as “a-profile”) to a cardholder based on the cardholder transaction data and stored profile, and generate an authenticity score (also referred to as “a-score”) for the merchant. The SA computing system is also configured to update or adjust the a-score as cardholders perform additional transactions with the merchant. The SA computing device updates the a-score by computing a transaction score for each transaction initiated by cardholders with the merchant. The SA computing device is further configured to generate reports using the a-scores. The reports may be made available to consumers, recommendation sites that use the information to create merchant recommendations, and/or to merchants for promoting their goods and/or services.

In at least some implementations, the SA computing system includes an SA computing device that is in communication with a payment processor computing device. In other embodiments, the SA computing device is integrated into or part of the payment processor computing device.

The SA computing device is configured to receive and store merchant parameter data. Merchant parameter data is data that describes the type of merchant a candidate merchant is, including if the merchant specializes in a particular type of product or services. For example, for a restaurant, merchant parameter data may include whether the restaurant is a Chinese restaurant or Mexican restaurant, whether it is formal or casual restaurant, and/or whether it is fast food or fine dining. The merchant parameter data may be collected when a merchant enrolls in the SA computing system. This parameter data may also be collected when the merchant subscribes to a transaction card system, such as a credit or debit card payment system using the MasterCard® or Visa® payment network. The SA computing device may also collect merchant parameter data by performing a lookup of the merchant on the Internet or by crawling certain websites to collect said data. In certain embodiments, the merchant may receive a merchant category code at the time of enrollment. The merchant category code may indicate the type of merchant the candidate merchant is. For example, the category code may differentiate a fine Chinese restaurant from a fast food Chinese restaurant. By collecting a merchant category code for each merchant, the SA computing device may compartmentalize merchants by merchant category code for further generating, for example, a-scores based on merchant type (also referred as to merchant segment). This may be done by storing the merchant category code in a database along with other merchant parameter data.

The SA computing device is further configured to build at least one authenticity parameter for each enrolled merchant. The a-parameter may be related to the types of goods and/or services the merchant advertises and/or sells (e.g., a key characteristic of the merchant). The a-parameter represents a key characteristic of the merchant and is the parameter being considered by the system for authenticity purposes. For example, the a-parameter may be a type of food, such as Mediterranean, Mexican, Southern, and the like. The a-parameter may also be a type of establishment, such as fine dining, kid-friendly, coffee shop, and the like. The a-parameter may further be a type of meal, such as brunch, lunch, small plates, and the like. The a-parameter may also represent the authenticity of the merchant with respect to a culture, such as Japanese, Indian, American, and the like. The SA computing device uses the stored merchant parameter data for building an a-parameter for a merchant. For example, the SA computing device may build an a-parameter for a merchant by using merchant parameter data indicating the merchant's location. The SA computing device may also build multiple a-parameters for one merchant. For example, a merchant may be a coffee shop located in Italy. The SA computing device may build two a-parameters for the merchant. One may be coffee-shop and the other may be Italian culture. In another example, a merchant may be an antique store selling antique Danish furniture. The SA computing device may build for said merchant the following a-parameters: antique, furniture, and Danish culture. As described below, the SA computing device will then evaluate the merchant using the a-parameter to determine how authentic the merchant is with respect to each a-parameter.

The SA computing device is also configured to receive transaction data. The transaction data is associated with a payment transaction, such as a transaction initiated using a payment card account. The transaction data includes, but is not limited to, a transaction identifier, a cardholder identifier, a merchant identifier, a transaction amount, and a transaction status code. The transaction data may be received from and/or generated by a payment processor associated with a payment processing network. In some embodiments, the SA computing device may identify, from the transaction data, locations where the cardholder has made purchases, and dates when these purchases were made. In addition, the SA computing device may be able to infer other data based on the transaction data. For example, the SA computing device may be able to infer a cardholder's home address and work address based on such transaction data. The SA computing device may then store the transaction data based on the cardholder identifier.

Cardholders and/or merchants may enroll in the score authenticator service. In certain embodiments, the cardholders and/or the merchants provide enrollment information to the SA computing device. In one example, a cardholder enrolling the score authenticator service may authorize the SA computing device to collect and use the cardholder transaction data. In another example, the cardholder may provide cardholder profile data, such as home address, work address, and the like. In yet another example, a merchant enrolling the score authenticator service may authorize SA computing device to collect and use merchant parameter data. In some embodiments, the cardholders and/or the merchants are automatically enrolled in the service. In such embodiments, the SA computing device is configured to enable the cardholders and/or the merchants to opt-out the service.

The SA computing device is also configured to assign an authenticity profile (a-profile) to each cardholder. The a-profile is a representation or an indication of how much of a “connoisseur” the cardholder is with respect to a particular a-parameter, in other words, the experience level of the cardholder with respect to the particular a-parameter. For example, the a-profile may indicate how knowledgeable a cardholder is with respect to Mediterranean food. In another example, the a-profile may indicate how experienced a cardholder is with respect to fine dining. The SA computing may determine the experience level of the cardholder with respect to an a-parameter by collecting the cardholder transaction data including, but not limited to, the primary account number (PAN), the cardholder bank identification number (BIN), which is part of the PAN, cardholder profile data, and transaction data, using the collected data to calculate or infer a value for a particular a-parameter.

In some embodiments, the SA computing device may assign an a-profile to a cardholder by identifying the BIN assigned to a transaction card used by the cardholder. The BIN assigned to a transaction card typically indicates the location of the issuer bank (e.g., the bank issuing the card) which is oftentimes an indicator of at least the country of origin of the cardholder. For example, if a transaction card was issued by a bank in France, the SA computing device may determine that the cardholder is French or at least resided in France for a period of time. Consequently, the SA computing device may determine the cardholder is knowledgeable with respect to French culture or at least having some experience in such culture. Thus, the SA computing device may assign the a-profile to the cardholder to include the cardholder knowledge on French culture, which may include food, wine, films, fashion, and the like.

In other embodiments, the SA computing device may assign an a-profile to a cardholder by collecting data from digital wallet transactions initiated by the cardholder. Digital wallet transactions provide a digital wallet identifier corresponding to the cardholder. The SA computing device may use the digital wallet identifier to identify the cardholder profile data, such as the cardholder's preferred language. From this data, the SA computing device may be able to infer other cardholder profile data, such as country of origin, home address, and the like. By identifying the cardholder profile data, the SA computing device may determine the experience level of the cardholder with respect to an a-parameter. For example, during a digital wallet registration process, cardholders may be asked for certain demographic data, such as their age and preferred language. Preferred language can aid in a determination of a country of origin of a cardholder because many countries have a national language. Thus, when the cardholder initiates a digital wallet transaction, the SA computing device may collect digital wallet data from the transaction and identify the preferred language, and thus, the country of origin of the cardholder. Once the country of origin is identified, the SA computing device may assign an a-profile to the cardholder that represents a higher level of knowledge of the cardholder for the country of origin as compared to other countries.

In yet other embodiments, the SA computing device may assign an a-profile to a cardholder by parsing the cardholder's transaction data. The transaction data may indicate the cardholder's interest in a particular a-parameter, and thus, the SA computing device may determine that the cardholder is more knowledgeable or experienced regarding that particular a-parameter because of an increased interest in said a-parameter. For example, a cardholder may frequent Japanese restaurants or other merchants that may be associated with Japanese culture, including merchants in Japan. The SA computing device may parse the cardholder transaction data and aggregate the transactions the cardholder made at such merchants. Based on the number of aggregated transactions, the SA computing device may determine that the cardholder is a “connoisseur” of Japanese culture, and thus, may assign an a-profile the cardholder that represents the cardholder's increased knowledge on the Japanese culture. The SA computing device may also determine that the cardholder is experienced with an a-parameter, such as the culture of a country, if the SA computing device identifies transactions that indicate that the cardholder traveled to said country.

The SA computing device may also update a cardholder's a-profile after receiving additional transaction data. In one example, a cardholder may initiate a transaction at a merchant with an a-parameter not included in the cardholder's a-profile. Once the transaction is received by the SA computing device, the SA computing device may add said a-parameter to the cardholder's a-profile and a score of the transaction (discussed below) to the newly added a-parameter. In another example, a cardholder may initiate a transaction at a merchant with an a-parameter included in the cardholder's a-profile. Once the transaction is received by the SA computing device, the SA computing device may add a score of the transaction to the a-parameter.

The SA computing device may also update a cardholder's a-profile after the SA computing device stops receiving, in a predetermined period of time, transaction data that includes data corresponding to at least one of the cardholder's interests. That is, the SA computing device may reduce the level of experience of a cardholder's interest if the SA computing device does not receive transaction data corresponding to that interest in a predetermined period of time.

The SA computing device is also configured to match a cardholder's a-profile to at least one merchant's a-parameter. In some embodiments, the SA computing device matches the cardholder's a-profile to the at least one merchant's a-parameter for determining a score of a transaction the cardholder has initiated at the merchant. The score is correlated to the degree of knowledge the cardholder has with respect to an a-parameter associated with the merchant. For example, a transaction initiated, by a cardholder knowledgeable of Chinese food, at a Chinese restaurant would have a greater impact on the merchant's a-score than a transaction initiated by a cardholder not knowledgeable of Chinese food. The SA computing device adds said score of the transaction (e.g., transaction score) to the cardholder's a-profile (e.g., score for the cardholder's interest) and the merchant's a-parameter (e.g., a-score for the merchant) because both may be integrated by said transaction. In other words, the transaction score updates the score for the cardholder's interest and the a-score for the merchant.

The a-score for merchant indicates or represents how “authentic” a merchant is to respect to a particular a-parameter. In other words, a merchant level of authenticity with respect to the goods and/or services the merchant advertises and/or sells. That is, the merchant authenticity level with respect to at least one a-parameter, which represents a key characteristic of the merchant. The SA computing device generates an a-score for the merchant based on the match of the interests of the cardholder to at least one key characteristic of the merchant, and an experience level of the cardholder in said matching interests. The SA computing device generates a merchant's a-score by aggregating the scores of transactions initiated by cardholders at said merchant. The score of each transaction may differ, as described above. The higher the a-score, the more authentic the merchant is. In one example, a merchant may advertise that it makes sushi. Thus, one of the merchant's a-parameters is Japanese cuisine.

In one embodiment, the SA computing device may generate the merchant's a-score by aggregating transactions initiated with the merchant and by cardholders with a Japanese a-profile (e.g., cardholders who are knowledgeable about Japanese food and/or culture). In another embodiment, the SA computing device may generate the merchant's a-score by taking into account the number of cardholders with a Japanese a-profile who live near the merchant and who have visited the merchant. In this case, the SA computing device may determine that transactions initiated by cardholders who live near the merchant have a higher score than transactions of those who do not. In an alternative embodiment, the SA computing device may generate the merchant's a-score by identifying cardholders who have recently traveled to Japan. For example, the SA computing device may give a higher score to transactions from cardholders who recently returned from Japan and have visited the merchant since.

In another embodiment, the SA computing device may generate the a-score for the merchant by identifying cardholders having a Japanese a-profile that reside at a greater distance from the merchant as compared to other merchants having the same merchant a-parameter. In other words, if a cardholder with a Japanese a-profile lives closer to other Japanese restaurants as compared to a candidate Japanese restaurant, but the cardholder visits the candidate Japanese restaurant on higher frequency count than the other closer Japanese restaurants, then the cardholder's transactions at the candidate Japanese restaurant would have a greater impact on the a-score for the candidate Japanese restaurant as compared transactions initiated by other cardholders.

In yet another embodiment, the SA computing device may generate a merchant's a-score by identifying the frequency cardholders with an interest that matches the merchant's a-parameter have visited the merchant in a predetermined period of time. In one example, the SA computing device may reduce the merchant's a-score if the SA computing device determines that visits of cardholders with an interest matching the merchant's a-parameter or key characteristic have decreased over a predetermined period of time.

In at least some embodiments, the SA computing device is configured to generate a-scores for specific a-parameters (e.g., type of food, such as sushi) and/or non-specific (e.g., Japanese cuisine). The SA computing device may make available the a-scores to consumers and/or to recommendation sites that may use the a-scores to create merchant recommendations. The SA computing device may also make available the a-scores to merchants who may use them to promote their goods and/or services.

In alternative embodiments, the SA computing device may transmit the a-scores via SMS text and/or over a network. The recipient may designate the type of communication channel that the SA computing device may use. Or, the SA computing device may be configured to use a default type of transmission when the recipient does not designate one.

The technical problems addressed by the SA computing system include at least one of: (i) inability to objectively score or rate an authenticity of a merchant; (ii) inability to determine a profile of a merchant that describes the key parameters of the merchant; (iii) inability to assign a profile of cardholders representing an expertise or knowledge base of the cardholder, (iv) inability of generating automatic outputs that may rate merchants based on their specialty, and (v) inability of generating automatic outputs that may rate merchants based on the profile of their consumers.

The methods and systems described herein may be implemented using computer programming or engineering techniques including computer software, firmware, hardware, or any combination or subset thereof, wherein the technical effects may be achieved by (i) receiving merchant parameter data relating to a candidate merchant including a merchant category code and a merchant identifier, (ii) building at least one authenticity parameter for the candidate merchant using the merchant parameter data, the at least one authenticity parameter representing at least one key characteristic of the merchant, (iii) identifying a cardholder having interacted with the candidate merchant, (iv) matching interests of the cardholder to the at least one key characteristic of the candidate merchant, and (v) generating an authenticity score for the candidate merchant based on the interests of the cardholder to the at least one key characteristic of the candidate merchant and an experience level of the cardholder in said matching interests.

The resulting technical benefits achieved by the SA computing system include at least one of: (i) new and improved usage of existing cardholder profile data received from cardholder and merchant computing devices, (ii) improved usage of existing merchant data, and (iii) ability of rating merchants based on their specialty and their consumers' profile.

In one embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer-readable medium and utilizes a Structured Query Language (SQL) with a client user interface front-end for administration and a web interface for standard user input and reports. In another embodiment, the system is web enabled and is run on a business entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus, are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the system and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

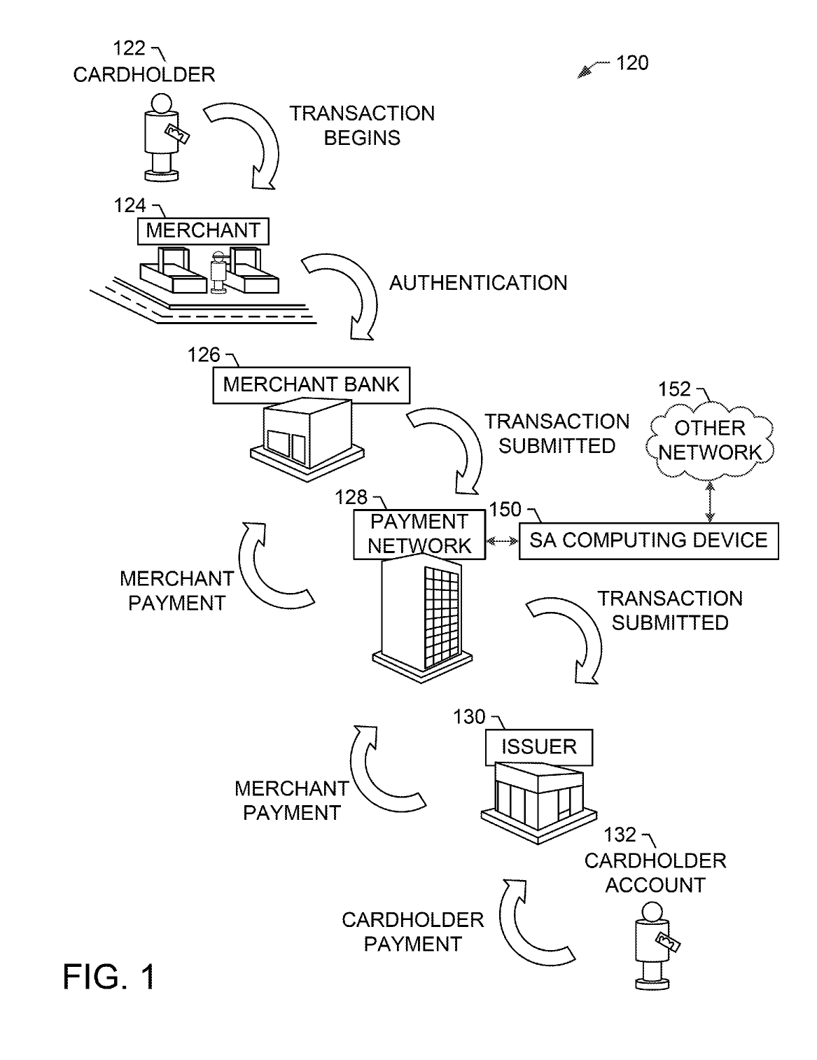

FIG. 1 is a schematic diagram illustrating an example score authenticator (SA) computing system 120 for generating authenticity scores by using device communication data, cardholder profile data, transaction data, and merchant parameter data. Embodiments described herein may relate to a transaction card system, such as a credit or debit card payment system using the MasterCard® or Visa® payment network. The MasterCard® payment network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.). Embodiments described herein include a score authenticator (SA) computing device 150 that is communicatively coupled to a payment network computing device 128. The SA computing device 150 is configured to receive transaction data, merchant parameter data, and cardholder profile data from payment network computing device 128 and generate authenticity scores by using device communication data, cardholder profile data, merchant parameter data, and transaction data. SA computing device can also get merchant parameter data for other data services by connecting into other network 152, which may include the Internet.

In the exemplary SA computing system, a financial institution called the “issuer” or “issuing bank” issues an account, such as a credit or debit card account, to cardholder 122, who uses the account to tender payment for a purchase from merchant 124. In one embodiment, cardholder 122 presents to merchant 124 a transaction card, such as a digital wallet using a user computing device, a credit card, debit card, or the like (also known as a card-present transaction). In another embodiment, cardholder 122 does not present the transaction card and instead performs a card-not-present (also referred as to “CNP”) transaction. For example, the CNP transaction may be initiated via a digital wallet application, through a website or web portal, via telephone, or any other method that does not require cardholder 122 to present a physical transaction card to merchant 124 (e.g., via scanning the digital wallet).

To accept payment during card-present and/or CNP transactions, merchant 124 establishes an account with a financial institution that is part of the financial payment system. This financial institution is usually called the “merchant bank,” the “acquiring bank,” or the “acquirer.” In one embodiment, cardholder 122 tenders payment for a purchase using a transaction card at a transaction processing device (e.g., a point of sale device), then merchant 124 requests authorization from merchant bank 126 for the amount of the purchase. The request is usually performed through the use of a point-of-sale terminal, which reads cardholder 122's account information from a magnetic stripe, a chip, barcode, or embossed characters on the transaction card and communicates electronically with the transaction processing computers of merchant bank 126. Alternatively, merchant bank 126 may authorize a third party to perform transaction processing on its behalf. In this case, the point-of-sale terminal will be configured to communicate with the third party. Such a third party is usually called a “merchant processor,” an “acquiring processor,” or a “third party processor.”

Using a payment network 128, computers of merchant bank 126 or merchant processor will communicate with computers of an issuer bank 130 to determine whether cardholder 122's account 132 is in good standing and whether the purchase is covered by cardholder 122's available balance. Based on these determinations, the request for authorization will be declined or accepted. If the request is accepted, an authorization code is issued to merchant 124.

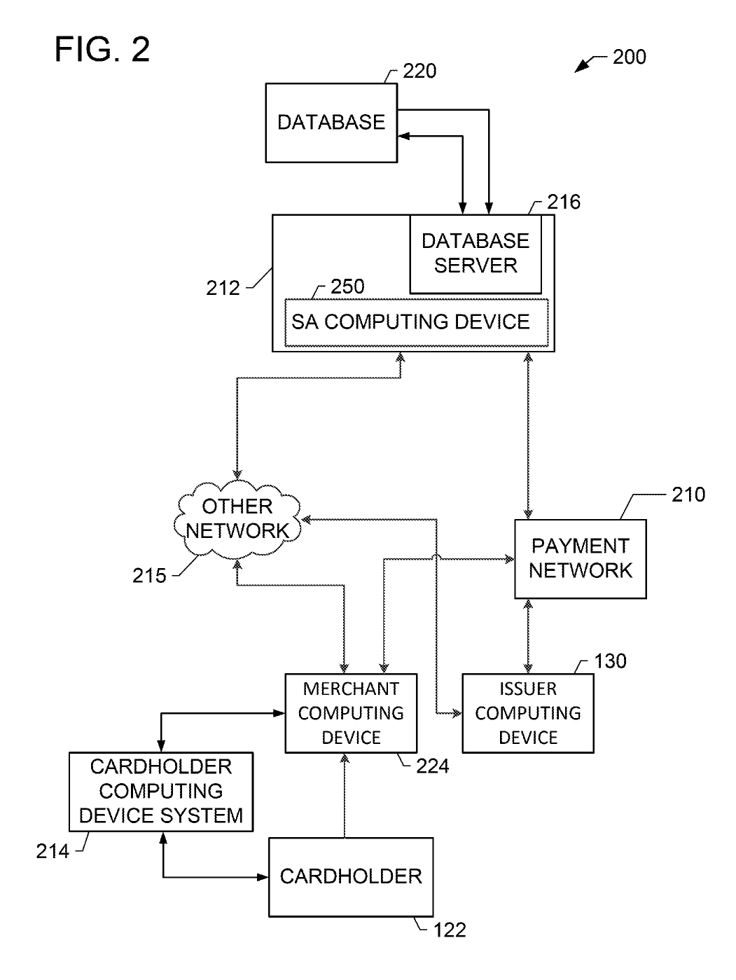

When a request for authorization is accepted, the available balance of cardholder 122's account 132 is decreased. Normally, a charge for a transaction card transaction is not posted immediately to cardholder 122's account 132 because bankcard associations, such as MasterCard International Incorporated®, have promulgated rules that do not allow merchant 124 to charge, or “capture,” a transaction until goods are shipped or services are delivered. However, with respect to at least some debit card transactions, a charge may be posted at the time of the transaction. When merchant 124 ships or delivers the goods or services, merchant 124 captures the transaction by, for example, appropriate data entry procedures on the point-of-sale terminal. This may include bundling of approved transactions daily for standard retail purchases. If cardholder 122 cancels a transaction before it is captured, a “void” is generated. If cardholder 122 returns goods after the transaction has been captured, a “credit” is generated. Payment network 128 and/or issuer bank 130 stores the transaction card information, such as a type of merchant, amount of purchase, date of purchase, in a database 220 (shown in FIG. 2).

After a purchase has been made, a clearing process occurs to transfer additional transaction data related to the purchase among the parties to the transaction, such as merchant bank 126, payment network 128, and issuer bank 130. More specifically, during and/or after the clearing process, additional data, such as a time of purchase, a merchant name, a type of merchant, purchase information, user account information, a type of transaction, information regarding the purchased item and/or service, and/or other suitable information, is associated with a transaction and transmitted between parties to the transaction as transaction data, and may be stored by any of the parties to the transaction. SA computing device crawls other network 152 to get merchant information and create merchant's a-parameter.

After a transaction is authorized and cleared, the transaction is settled among merchant 124, merchant bank 126, and issuer bank 130. Settlement refers to the transfer of financial data or funds among merchant 124's account, merchant bank 126, and issuer bank 130 related to the transaction. Usually, transactions are captured and accumulated into a “batch,” which is settled as a group. More specifically, a transaction is typically settled between issuer bank 130 and payment network 128, and then between payment network 128 and merchant bank 126, and then between merchant bank 126 and merchant 124.

As described above, the various parties to the transaction card transaction include one or more of the parties shown in FIG. 1 such as, for example, cardholder 122, merchant 124, merchant bank 126, payment network 128 (also referred to herein as payment processor 128), and/or issuer bank 130 that may include, an issuer processor.

FIG. 2 is a simplified block diagram of an example score authenticator (SA) computing system 200, in which a variety of computing devices are communicatively coupled to each other via a plurality of network connections. These network connections may be Internet, LAN/WAN, or other connections capable of transmitting data across computing devices. SA computing system 200 includes score authenticator (SA) computing device 250 and database server 216. In one embodiment, SA computing device 250 and database 216 are components of server system 212. Server system 212 may be a server, a network of multiple computer devices, a virtual computing device, or the like. SA computing device 250 is connected to at least one merchant computing device 224, and an issuer computing device 130 via at least a payment network 210 (similar to payment network 128 shown in FIG. 1). SA computing device 250 is also connected to at least one merchant computing device 224 via other network 215 (similar to other network 152 shown in FIG. 1).

In one embodiment, SA computing device 250 is configured to receive cardholder 122 transaction data from merchant computing device 224, over payment network connection 210. As noted with respect to FIG. 1, when cardholder 122 performs a transaction at merchant 126, transaction data is generated. Transaction data may be transmitted across computer devices as an authorization data message. In one embodiment, when cardholder 122 performs a transaction at merchant computing device 224 associated with merchant 124, transaction data for the transaction is transmitted to server system 212. Server system 212 processes the transaction data in the manner described with respect to FIG. 1 and also transmits such data to SA computing device 250.

The authorization data message may also include a transaction amount, a transaction date, account data related to the transaction card used to perform the transaction (e.g., primary account number associated with transaction card, card expiration date, card issuer, card security code, or the like), a merchant identifier, stock-keeping unit (SKU) data relating to the goods or services purchased by cardholder 122, or the like. In one embodiment, the authorization data message also includes location data. As used herein, address data, city data, state data, zip or postal code data, country data, merchant location identifier data, IP address data, MAC address data, or the like. In another embodiment, the authorization data message further includes digital wallet data. This digital wallet data may contain the cardholder's demographics that may correspond to the cardholder's age, place of origin, gender, and the like. SA computing device 250 is configured to collect merchant parameter data from a merchant via payment network 210 or other network 215. SA computing device 250 is also configured to store the merchant parameter data, build at least one authenticity parameter (also referred to as “a-parameter”) for a merchant, receive cardholder transaction data, assign an authenticity profile (also referred to as “a-profile”) to a cardholder based on the cardholder transaction data and stored profile, match the cardholder's a-profile to the at least one merchant's a-parameter, and generate an authenticity score (also referred to as “a-score”) for the merchant. SA computing device 250 is also configured to adjust a-profiles and a-scores as cardholders perform transactions, and generate reports using the a-scores. The reports may be made available to consumers, recommendation sites that use the information to create merchant recommendations, and/or to merchants for promoting their goods and/or services.

Database server 216 is connected to database 220, which contains information on a variety of matters, as described below in greater detail. In one embodiment, database 220 is stored on server system 212 and can be accessed by potential users of server system 212. In an alternative embodiment, database 220 is stored remotely from server system 212 and may be non-centralized. Database 220 may include a single database having separated sections or partitions or may include multiple databases, each being separate from each other. Database 220 may store transaction data for each user in communication with SA computing device 250.

In the example embodiment, SA computing device 250 includes specifically designed computer hardware to perform the steps described herein, and includes specifically designed computer implementation instructions. SA computing device 250 is a specially designed and customized computer device built to perform the specific function of collecting transaction data from a payment transaction initiated by a cardholder for building an a-parameter for a merchant, assigning an a-profile to the cardholder, generating a merchant's a-score, and generating reports using the a-scores. SA computing device 250 may make the reports available to consumers and recommendation sites that use the information to create merchant recommendations, and/or to merchants for promoting their goods and/or services.

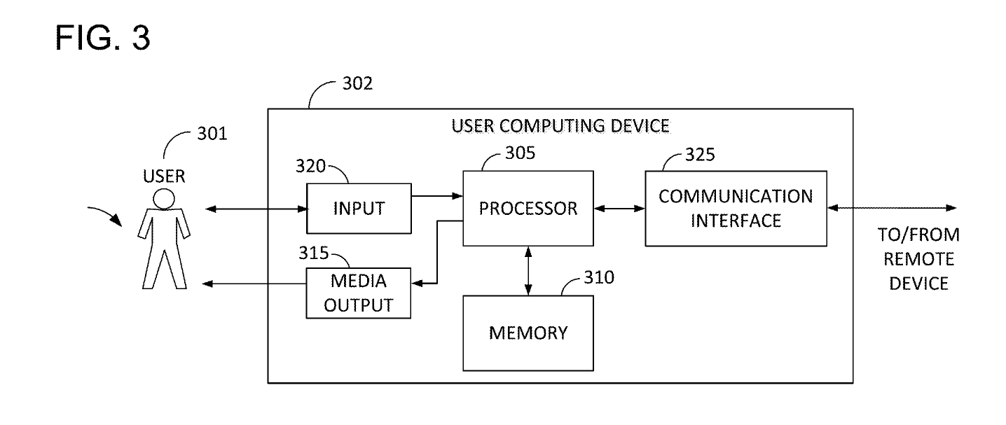

FIG. 3 illustrates an example configuration of a system, such as cardholder computing device 214 or merchant computing device 224 (shown in FIG. 2) configured to transmit data to SA computing device 250 (shown in FIG. 2). User system 302 may include, but is not limited to, cardholder computing device 214 or merchant computing device 224. In the example embodiment, user system 302 includes a processor 305 for executing instructions. In some embodiments, executable instructions are stored in a memory area 310. Processor 305 may include one or more processing units, for example, a multi-core configuration. Memory area 310 is any device allowing information such as executable instructions and/or written works to be stored and retrieved. Memory area 310 may include one or more computer readable media.

User system 302 also includes at least one media output component 315 for presenting information to user 301. User 301 may include, but is not limited to, cardholder 122 or merchant 124. Media output component 315 is any component capable of conveying information to user 301. For example, media output component 315 may be a display component configured to display component lifecycle data in the form of reports, dashboards, communications, or the like. In some embodiments, media output component 315 includes an output adapter such as a video adapter and/or an audio adapter. An output adapter is operatively coupled to processor 305 and operatively connectable to an output device, such as a display device, a liquid crystal display (LCD), organic light emitting diode (OLED) display, or “electronic ink” display, or an audio output device, a speaker or headphones.

In some embodiments, user system 302 includes an input device 320 for receiving input from user 301. Input device 320 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 315 and input device 320. User system 302 may also include a communication interface 325, which is communicatively connectable to a remote device, such as server system 212 (shown in FIG. 2). Communication interface 325 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 310 are, for example, computer readable instructions for providing a user interface to user 301 via media output component 315 and, optionally, receiving and processing input from input device 320. A user interface may include, among other possibilities, a web browser and client application. Web browsers enable users, such as user 301, to display and interact with media and other information typically embedded on a web page or a website from server system 212. A client application allows user 301 to interact with a server application from server system 212.

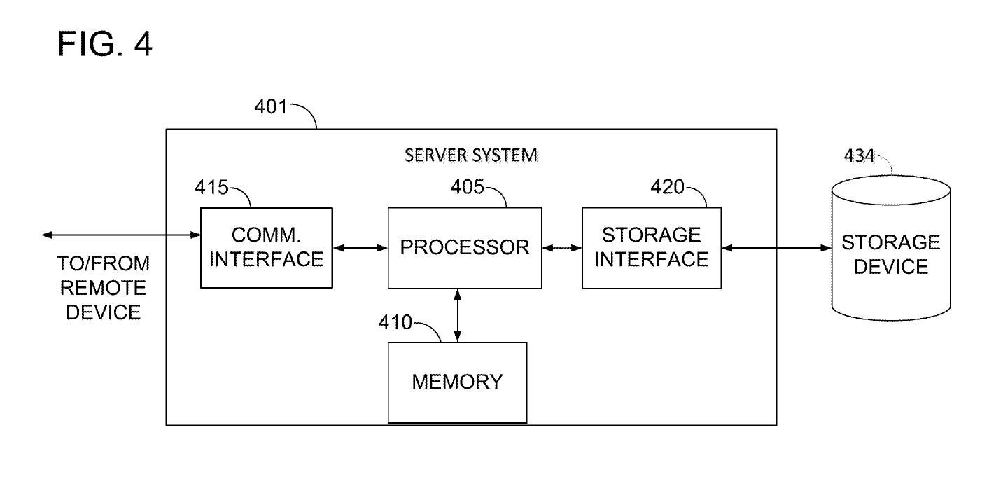

FIG. 4 illustrates an example configuration of server system 401, such as server system 212 (shown in FIG. 2) that includes SA computing device 250 (shown in FIG. 2). Server system 401 may include, but is not limited to, database server 216 (shown in FIG. 2) or SA computing device 250. In some embodiments, server system 401 is similar to server system 212.

Server system 401 includes processor 405 for executing instructions. Instructions may be stored in memory area 410, for example. Processor 405 may include one or more processing units (e.g., in a multi-core configuration) for executing instructions. The instructions may be executed within a variety of different operating systems on server system 401, such as UNIX, LINUX, Microsoft Windows®, etc. More specifically, the instructions may cause various data manipulations on data stored in storage 434 (e.g., create, read, update, and delete procedures). It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 405 is operatively coupled to communication interface 415 such that server system 401 is capable of communicating with a remote device, such as user system 302 (shown in FIG. 3) or another server system 401. For example, communication interface 415 may receive communications from issuer computing device 130 via the Internet, as illustrated in FIG. 2.

Processor 405 may also be operatively coupled to storage device 434. Storage device 434 is any computer-operated hardware suitable for storing and/or retrieving data. In some embodiments, storage device 434 is integrated in server system 401. In other embodiments, storage device 434 is external to server system 401 and is similar to database 220 (shown in FIG. 2). For example, server system 401 may include one or more hard disk drives as storage device 434. In other embodiments, storage device 434 is external to server system 401 and may be accessed by a plurality of server systems 401. For example, storage device 434 may include multiple storage units such as hard disks or solid state disks in a redundant array of inexpensive disks (RAID) configuration. Storage device 434 may include a storage area network (SAN) and/or a network attached storage (NAS) system.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

Memory area 410 may include, but is not limited to, random access memory (RAM), such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

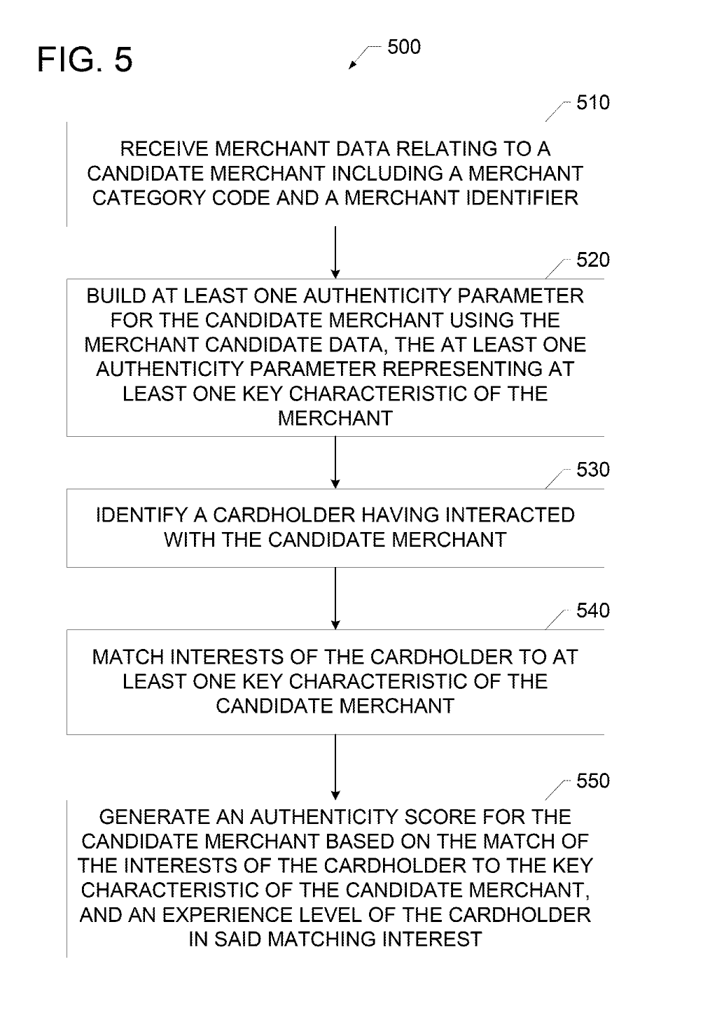

FIG. 5 is an example flow diagram illustrating a process 500 by which SA computing device 250 (shown in FIG. 2) collects transaction data from payment transactions initiated by cardholder 122 (shown in FIG. 2) for building an authenticity parameter (a-parameter) for merchant 124 (shown in FIG. 1) and using the a-parameter to generate an authenticity score (a-score) for merchant 124. In the example embodiment, SA computing device 250 receives 510 merchant parameter data relating to a candidate merchant as part of a merchant enrollment in the SA computing system, as illustrated in FIG. 1. SA computing device 250 may also receive 510 such parameter data when merchant 124 subscribes to a transaction card system, such as a credit or debit card payment system using the MasterCard® or Visa® payment network. SA computing device 250 may further receive 510 the merchant parameter data after performing a lookup of the merchant on the Internet or by crawling certain websites to collect said data. In certain embodiments, the merchant parameter data may include a merchant category code. The merchant category code may indicate the type of merchant 124 candidate merchant 124 is. By collecting a merchant category code for each merchant, SA computing 250 device may compartmentalize merchants by merchant category code for further generating, for example, a-scores for any given merchant based on merchant type (also referred as to merchant segment). This can be done by storing the merchant category code in a database along with other merchant parameter data.

SA computing device 250 also builds 520 at least one authenticity parameter (a-parameter) for each enrolled merchant. The a-parameter may be related to the types of goods and/or services merchant 124 advertises and/or sells (e.g., a key characteristic of the merchant). For example, the a-parameter may be a type of food, such as Mediterranean, Mexican, Southern, and the like. The a-parameter may also be a type of establishment, such as fine dining, kid-friendly, coffee shop, and the like. SA computing device 250 uses the stored merchant parameter data for building a-parameter for a merchant. For example, SA computing device 250 may build an a-parameter for a merchant by using merchant parameter data indicating the merchant's location. SA computing device 250 may also build multiple a-parameters for one merchant. For example, a merchant may be a hair salon located in South Africa. SA computing device 250 may build two a-parameters for the merchant. One may be hair salon and the other may be South African culture.

SA computing device also identifies 530 a cardholder having interacted with merchant 124. SA computing may identify 530 said cardholder using transaction data, which SA computing device receives as part of a payment transaction initiated by cardholder 122 (shown in FIG. 1). At the time cardholder 122 initiates a transaction, merchant computing device 224 (shown in FIG. 2) creates transaction data. After transaction data is created, SA computing device 250 receives such data, which may include a merchant identifier and a cardholder identifier. The transaction data is associated with transactions initiated by cardholder 122 with merchant 124. The transaction data is also associated with transaction cards associated with payment accounts of cardholder 122. In some embodiments, cardholder transaction data may include cardholder 122's primary account number (PAN), which include cardholder 122's bank identification number (BIN), cardholder 122 profile data, and transaction data. Cardholder 122 profile data is frequently received from transactions initiated via a digital wallet. SA computing device 250 may infer from digital wallet cardholder 122's country of origin, home address, work address, or the like.

SA computing device 250 further assigns an a-profile to cardholder 122 using cardholder 122 transaction data and stored cardholder 122 profile data. The a-profile includes at least one cardholder interest in a particular a-parameter. The stored profile data may include cardholder 122 personal information described above. In some embodiments, SA computing device 250 may assign the a-profile to cardholder 122 by identifying the cardholder BIN. The BIN assigned to a transaction card indicates the location of issuer 130 which may be an indicator of cardholder 122's place of origin. For example, if issuer 130 is in Italy, SA computing device 250 may determine that cardholder 122 is Italian or at least resided in Italy for a period of time. Consequently, SA computing device 250 may determine cardholder 122 is knowledgeable with respect to Italian culture. Thus, SA computing device 250 may assign the a-profile to cardholder 122 to include cardholder 122's knowledge of Italian culture, which may include food, wine, films, fashion, and the like.

In other embodiments, SA computing device 250 may assign cardholder 122 a-profile by collecting data from digital wallet transactions initiated by cardholder 122. Digital wallet transactions provide a digital wallet identifier corresponding to cardholder 122. SA computing device 250 may use the digital wallet identifier to identify profile data corresponding to cardholder 122. From this data, SA computing device 250 may be able to infer other cardholder 122 data, such as cardholder 122 preferred language, country of origin, home address, or the like. By identifying cardholder 122 profile data, SA computing device 250 may determine how knowledgeable cardholder 122 is with respect to an a-parameter associated with at least one merchant 124's key characteristic. For example, during a digital wallet registration process, cardholder 122 may be asked for certain demographic data, such as cardholder 122 age and preferred language. Preferred language can aid in a determination of a country of origin of cardholder 122 because many countries have a national language. Thus, when cardholder 122 initiates a digital wallet transaction, SA computing device 250 may collect digital wallet data from the transaction and identify the preferred language, and thus, the country of origin of cardholder 122. Once the country of origin is identified, SA computing device 250 may assign the a-profile to cardholder 122 that represents a higher level of knowledge of cardholder 122 for the country of origin as compared to other countries.

In yet other embodiments, SA computing device 250 may assign an a-profile to cardholder 122 by parsing cardholder 122 transaction data. The transaction data may indicate that cardholder 122's interest in a particular a-parameter, and thus, SA computing device 250 may determine that cardholder 122 is more knowledgeable regarding that particular a-parameter because of an increased interest in said a-parameter. For example, cardholder 122 may frequent Indian restaurants or other merchants that may be associated with Indian culture, including merchants in India. SA computing device 250 may parse cardholder 122 transaction data and aggregate the transactions cardholder 122 made at such merchants. Based on the number of aggregated transactions, SA computing device 250 may determine that cardholder 122 is a “connoisseur” of Indian culture and assign an a-profile to cardholder 122 that represents the cardholder 122's increased knowledge on the Indian culture. SA computing device 250 may also determine cardholder 122 is experienced with respect to an a-parameter, such as the culture of a country, if SA computing device 250 identifies transactions that indicate that cardholder 122 traveled to said country. SA computing device 250 may also determine that cardholder 122 is experienced with an a-parameter, such as the culture of a country, if SA computing device 250 identifies transactions that indicate that cardholder 122 traveled to said country. SA computing device 250 may also update cardholder 122's a-profile after receiving additional transaction data. In one example, cardholder 122 may initiate a transaction at merchant 124 which parameter data may include an a-parameter not included in cardholder 122's a-profile. Once the transaction is received by SA computing device 250, SA computing device may add said a-parameter to cardholder 122's a-profile and a score of the transaction (described below) to the newly added a-parameter. In another example, cardholder 122 may initiate a transaction at merchant 124 which parameter data may include an a-parameter included in cardholder 122's a-profile. Once the transaction is received by SA computing device 250, SA computing device 250 may add a score of the transaction to the a-parameter.

SA computing device 250 further matches 540 interests of cardholder 122 to at least one key characteristic of merchant 124. In some embodiments, SA computing device 250 matches 540 interests of cardholder 122 to at least one key characteristic of merchant 124 for generating a score for a transaction initiated by cardholder 122 with merchant 124. The score is correlated to the degree of knowledge cardholder 122 has with respect to a key characteristic associated with merchant 124. For example, a transaction initiated by cardholder 122 at merchant 124 has a higher score when cardholder 122's a-profile includes an interest that matches merchant 124's key characteristic than when the a-profile does not. SA computing device 250 adds the score of the transaction (e.g., transaction score) to the cardholder 122's a-profile (e.g., score for the cardholder's interest) and the merchant 124's a-parameter (e.g., a-score for the merchant).

The a-score for merchant 124 indicates or represents how “authentic” merchant 124 is with respect to a particular parameter. In other words, merchant 124 level of authenticity with respect to the goods and/or services merchant 124 advertises and/or sells. That is, merchant 124 authenticity level with respect to at least one a-parameter which represents a key characteristic of merchant 124. SA computing device 250 generates 550 an a-score for merchant 124 based on the match of interests of cardholder 122 to at least one key characteristic of merchant, and an experience level of cardholder 122 in said matching interests. SA computing device 250 also generates 550 the score for merchant 124 by aggregating the scores of transactions initiated by cardholders with merchant 124. The score of each transaction may differ, as described above. The higher the a-score, the more authentic merchant 124 is. In one example, a merchant may advertise that it makes gyros. Thus, one of merchant 124's assigned a-parameters is Greek cuisine.

In one embodiment, SA computing device 250 may generate 550 merchant 124's a-score by aggregating transactions initiated with merchant 124 and by cardholders with a Greek a-profile (e.g., cardholders who are knowledgeable about Greek food and/or culture). In another embodiment, SA computing device 250 may generate 550 merchant 124's a-score by taking into account the number of cardholders with a Greek a-profile who live near merchant 124 and who have visited merchant 124. In this case, SA computing device 250 may determine that transactions initiated by cardholders who live near merchant 124 have a higher score than transactions of those who do not. In an alternative embodiment, SA computing device 250 may generate 550 merchant 124's a-score by identifying cardholders who have recently traveled to Greece. For example, SA computing device 250 may give a higher score to transactions from cardholders who recently returned from Greece and have visited merchant 124 since.

In another embodiment, SA computing device 250 may generate 550 the a-score of merchant 124 by identifying cardholders having a Greek a-profile that reside a greater distance from merchant 124 as compared to other merchants having the same merchant a-parameter. In other words, if cardholder 122 with a Greek a-profile lives closer to other Greek restaurants as compared to a candidate Greek restaurant, in this case merchant 124, but cardholder 122 visits the candidate Greek restaurant on higher frequency count than the other closer Greek restaurants, then cardholder 122's transactions at merchant 124 would have a greater impact on a-score for merchant 124 as compared transactions initiated by other cardholders.

In at least some embodiments, SA computing device 250 is configured to generate 550 a-scores for specific a-parameters (e.g., type of food, such as falafel) and/or non-specific (e.g., Greek cuisine). SA computing device 250 may make available the a-scores to consumers and/or to recommendation sites that may use the a-scores to create merchant recommendations. SA computing device 250 may also make available the a-scores to merchants who may use them to promote their goods and/or services.

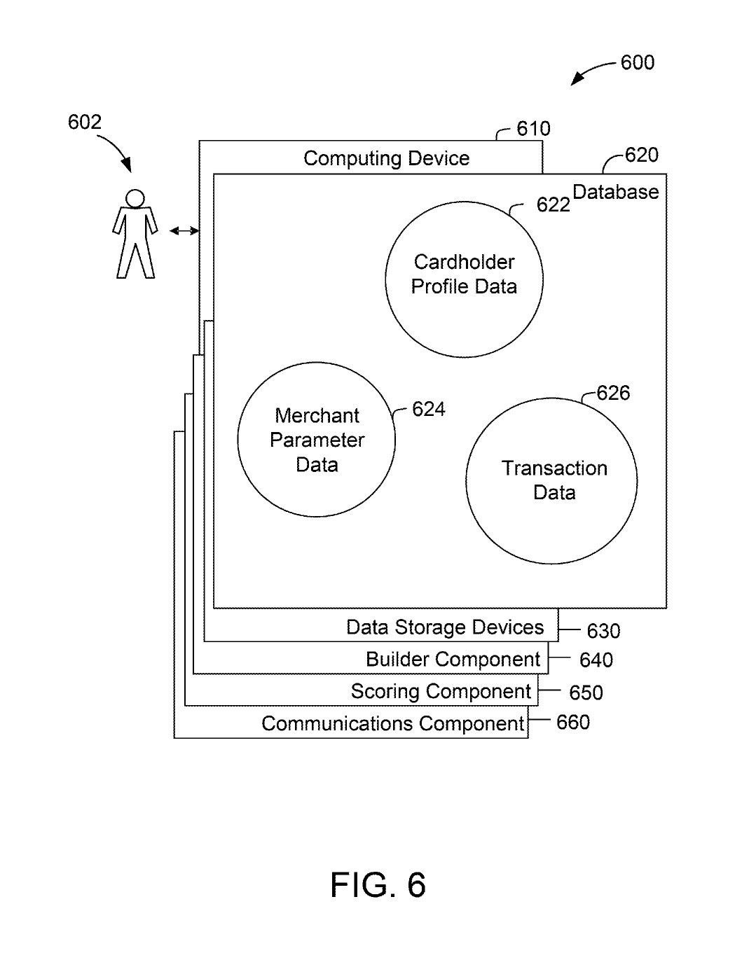

FIG. 6 shows an example configuration of a database 600 within a computing device, along with other related computing components, that may be used to receive merchant 124 (shown in FIG. 1) data relating to merchant 124, and to build at least one authenticity parameter for merchant 124. Database 600 may also be used to collect transaction data from a payment transaction initiated by cardholder 122 (shown in FIG. 2) for assigning an a-profile to cardholder 122, using the a-profile to generate an a-score for a merchant, and generating reports using the a-scores. SA computing device 250 may make the reports available to consumers and recommendation sites that use the information to create merchant recommendations, and/or to merchants for promoting their goods and/or services. In some embodiments, computing device 610 is similar to server system 212 (shown in FIG. 2). User 602 (such as a user of operating server system 212) may access computing device 610 in order to verify records in the data table corresponding to cardholder 122. In some embodiments, database 620 is similar to database 220 (shown in FIG. 2). In the example embodiment, database 620 includes cardholder profile data 622, merchant parameter data 624, and transaction data 626. Cardholder profile data 622 may include cardholder 122 personal data (e.g., address, city, state, zip or postal code, country, account information, such as account identifier), cardholder 122 computing device data (e.g., IP address data, MAC address data), and cardholder 122's a-profile data (e.g., score per interest, date a-profile per a-parameter was last updated).

Merchant parameter data 624 may include merchant 124 business data (e.g., address, city, state, zip or postal code, country, telephone number, account information, such as account identifier), merchant 124 data (e.g., merchant location, merchant identifier, merchant type), and merchant 124's a-parameter data (e.g., merchant category code, a-score). Transaction data 626 may include transaction amounts, transaction dates/times, account data related to the transaction card used to perform the transaction (e.g., primary account number associated with transaction card, card expiration date, card issuer, card security code, and the like), merchant identifiers, stock-keeping unit (SKU) data relating to the goods or services purchased by cardholder 122, parameter data, and the like.

Computing device 610 may be SA computing device 250. Computing device 610 includes data storage devices 630. Computing device 610 also includes builder component 640 that builds a data table based on transaction data, cardholder profile data, and merchant parameter data. Builder component 640 may perform, for example, receiving merchant 124 data relating to merchant 124, and building 520 (shown in FIG. 5) merchant 124's a-parameter using merchant 124 data (e.g., merchant parameter data 624). Builder component 640 may also perform, for example, receiving transaction data 626 initiated with merchant 124 and by cardholder 122, and parsing cardholder 122 transaction data 626 and retrieving from transaction data 626 data corresponding to a particular a-parameter of merchant 124.

Computing device 610 also includes scoring component 650 that facilitates scoring merchant 124's a-parameter. Scoring component 650 may also perform, for example, matching 540 (shown in FIG. 5) interests of cardholder 122 to at least one key characteristic of merchant 124, and generating 540 (shown in FIG. 5) an a-score for the merchant. Computing device 610 also includes communications component 660 which is used to communicate with issuer computing devices, merchant computing devices, and/or other computing devices using predefined network protocols such as TCP/IP (Transmission Control Protocol/Internet Protocol) over the Internet.

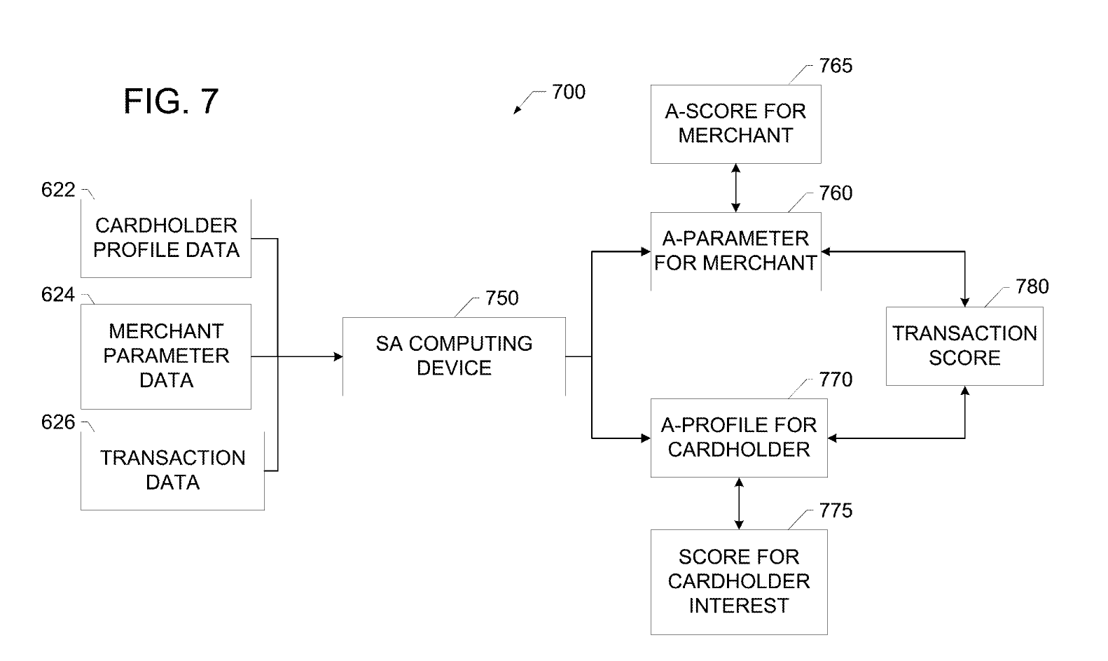

FIG. 7 illustrates an example configuration of a SA system 700 that includes SA computing device 750 (similar to SA computing device 250 shown in FIG. 2) configured to collect cardholder profile data 622, merchant parameter data 624, and transaction data 626. In one embodiment, SA computing device 750 builds 520 (shown in FIG. 5) a-parameter for a merchant 760 using merchant parameter data 624 and/or transaction data 626. In another embodiment, SA computing device 750 assigns a-profile for cardholder 770 using cardholder profile data 622 and/or transaction data 622. In yet another embodiment, SA computing device 750 matches 540 interests of a cardholder to at least one key characteristic of merchant for generating a score for a transaction (e.g., transaction score 780) initiated by the cardholder with the merchant. The score is correlated to the degree of knowledge the cardholder has with respect to a key characteristic associated with the merchant. SA computing device 750 aggregates transaction score 780 to a-score for merchant 765 corresponding to a-parameter for merchant 760. SA computing device 750 also aggregates transaction score 780 to score for cardholder interest 775 corresponding to a-profile for cardholder 770.

As will be appreciated based on the foregoing specification, the above-described embodiments of the disclosure may be implemented using computer programming or engineering techniques including computer software, firmware, hardware or any combination or subset thereof, wherein the technical effect is to collect data from computer devices connected in communication by a computer network generating authenticity scores by using device communication data, cardholder profile data, merchant parameter data, and transaction data. Any such resulting program, having computer-readable code means, may be embodied or provided within one or more computer-readable media, thereby making a computer program product, (i.e., an article of manufacture), according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A network-based system for generating an authenticity score for a merchant using a score authenticator (SA) computing device, the SA computing device coupled to a database and including at least one processor in communication with at least one memory device, said SA computing device configured to:
receive merchant parameter data relating to a candidate merchant including a merchant category code and a merchant identifier;
build at least one authenticity parameter for the candidate merchant using the merchant parameter data, the at least one authenticity parameter representing at least one key characteristic of the merchant;
identify a cardholder having interacted with the candidate merchant;
match interests of the cardholder to at least one key characteristic of the candidate merchant; and
generate an authenticity score for the candidate merchant based on:
the match of the interests of the cardholder to the key characteristic of the candidate merchant; and
an experience level of the cardholder in said matching interests.

2. The SA computing device of claim 1 further configured to:
collect the merchant parameter data in response to the candidate merchant enrolling in a payment network system, wherein the merchant parameter data includes the at least one key characteristic of the merchant;
parse the merchant parameter data to determine the at least one key characteristic of the candidate merchant; and
retrieve, from the merchant parameter data, the at least one key characteristic of the candidate merchant.

3. The SA computing device of claim 2, wherein the SA computing device is further configured to collect the merchant parameter data by crawling a network.

4. The SA computing device of claim 1 further configured to:
receive transaction data for a cardholder, the transaction data relating to a payment transaction initiated by the cardholder with a merchant;
collect cardholder profile data from an issuer; and
assign a cardholder authenticity profile for the cardholder using the transaction data and the cardholder profile data, wherein the cardholder authenticity profile includes the interests of the cardholder and the experience level of the cardholder in said interests.

5. The SA computing device of claim 4, wherein the transaction data includes merchant identifier data and at least one item identifier identifying a product or service purchased by the cardholder.

6. The SA computing device of claim 4, wherein the transaction data is received by the SA computing device as part of an ISO 8583 clearing message, the transaction data including a cardholder identifier, a merchant location, and a transaction date.

7. The SA computing device of claim 1 further configured to:
store the merchant parameter data in at least one memory device, wherein the merchant parameter data is stored in association with at least one merchant identifier identifying the at least one merchant such that a merchant identifier for the at least one merchant is associated with an authenticity profile for at least one cardholder conducting payment transactions the at least one merchant.

8. The SA computing device of claim 1, wherein generate the authenticity score for the candidate merchant includes aggregating transactions initiated by at least one cardholder with the candidate merchant.

9. The SA computing device of claim 1, wherein generate the authenticity score for the candidate merchant includes adding a plurality of scores based on whether the interests of the cardholder matches to the at least one key characteristic of the candidate merchant.

10. The SA computing device of claim 1 further configured to:
receive an authenticity score report request from a requester, wherein the authenticity score report request includes at least one merchant identifier;
compare the at least one merchant identifier to at least one merchant with a determined authenticity score; and
transmit the authenticity score of the at least one merchant with a determined authenticity score to the requester.

11. A computer-based method for generating an authenticity score for a merchant, said method performed using a score authenticator (SA) computing device comprising at least one processor in communication with at least one memory device, said method comprising:
receiving merchant parameter data relating to a candidate merchant including a merchant category code and a merchant identifier;
building at least one authenticity parameter for the candidate merchant using the merchant parameter data, the at least one authenticity parameter representing at least one key characteristic of the merchant;
identifying a cardholder having interacted with the candidate merchant;
matching interests of the cardholder to the at least one key characteristic of the candidate merchant; and
generating an authenticity score for the candidate merchant based on:
the match of the interests of the cardholder to the at least one key characteristic of the candidate merchant; and
an experience level of the cardholder in said matching interests.

12. The method of claim 11 further comprising:
collecting the merchant parameter data in response to the candidate merchant enrolling in a payment network system, wherein the merchant parameter data includes the at least one key characteristic of the candidate merchant;
parsing the merchant parameter data to determine the at least one key characteristic of the candidate merchant; and
retrieving, from the merchant parameter data, the at least one key characteristic of the candidate merchant.

13. The method of claim 12 further comprising collecting the merchant parameter data by crawling a network.

14. The method of claim 11 further comprising:
receiving transaction data for a cardholder, the transaction data relating to a payment transaction initiated by the cardholder with a merchant;
collecting cardholder profile data from an issuer; and
assigning a cardholder authenticity profile for the cardholder using the transaction data and the cardholder profile data, wherein the cardholder authenticity profile includes interests of the cardholder and the experience level of the cardholder in said interests.

15. The method of claim 11, wherein the transaction data includes merchant identifier data and at least one item identifier identifying a product or service purchased by the cardholder.

16. The method of claim 11, wherein the transaction data is received by the SA computing device as part of an ISO 8583 clearing message, the transaction data including a cardholder identifier, a merchant location, and a transaction date.

17. The method of claim 11 further comprising:
storing the merchant parameter data in at least one memory device, wherein the merchant parameter data is stored in association with at least one merchant identifier identifying the at least one merchant such that a merchant identifier for the least one merchant is associated with an authenticity profile for at least one cardholder conducting payment transactions at the at least one merchant.

18. The method of claim 11, wherein generating the authenticity score for the candidate merchant includes aggregating transactions initiated by at least one cardholder with the candidate merchant.

19. The method of claim 11, wherein generating the authenticity score for the candidate merchant includes adding a plurality of scores based on whether the interests of the cardholder matches to the at least one key characteristic of the candidate merchant.

20. The method of claim 11 further comprising:
receiving an authenticity score report request from a requester, wherein the authenticity score report request includes at least one merchant identifier;
comparing the at least one merchant identifier to at least one merchant with a determined authenticity score; and
transmitting the authenticity score of the at least one merchant with a determined authenticity score to the requester.

21. A non-transitory computer readable medium that include a executable instructions for generating authenticity score for a merchant by using device communication data, cardholder profile data, merchant parameter data, and transaction data, wherein when executed by a score authenticator (SA) computing device comprising at least one processor in communication with at least one memory device, the computer executable instructions cause the SA computing device to:
receive merchant parameter data relating to a candidate merchant including a merchant category code and a merchant identifier;
build at least one authenticity parameter for the candidate merchant using the merchant parameter data, the at least one authenticity parameter representing at least one key characteristic of the merchant;
identify a cardholder having interacted with the candidate merchant
match interests of the cardholder to at least one key characteristic of the candidate merchant; and
generate an authenticity score for the candidate merchant based on:
the match of the interests of the cardholder to the key characteristic of the candidate merchant; and
an experience level of the cardholder in said matching interests.
